(19) United States
(12) Patent Application Publication
(10) Pub. No.: US 2010/0116508 A1
(43) Pub. Date: May 13, 2010

(54) Hydraulic Pump-Drive Downhole Fluids Pump With Linear Driver

(76) Inventor: Kenneth Doyle Oglesby, Tulsa, OK (US)

Correspondence Address: HEAD, JOHNSON & KACHIGIAN, 228 W 17TH PLACE, TULSA, OK, 74119, US

(21) Appl. No.: 12/451,448

(22) PCT Filed: May 20, 2008
(86) PCT No.: PCT/US2008/006468

§ 371 Date: Nov. 12, 2009

Related U.S. Application Data
(60) Provisional application No. 60/931,071, filed on May 21, 2007.

(51) Int. Cl. E21B 43/00; F04B 17/00; F04B 23/04; F04B 47/04; F15B 1/04; E21B 23/00

(52) U.S. Cl. 166/369; 417/379; 417/399; 417/410.1; 417/426; 60/413; 166/66.4

(57) ABSTRACT

A downhole pump assembly for removing volumes of liquids, crude oils, gases, and produced waters, from oil or gas wells is described based on a downhole controllable electric drive, and a positive displacement pump, wherein the electric drive powers a hydraulic pump that powers the positive displacement pump.

### CROSS-REFERENCE TO RELATED APPLICATIONS

This application claims the benefit of U.S. provisional Ser. No. 60/931,071, filed May 21, 2007 by the present inventor.

### BACKGROUND

Deep gas wells (greater than 8,000 ft.) and shallow oil or gas wells need downhole pumps to remove low volumes of liquids, crude oils and produced waters, to the surface. Removal of these liquids allows continued production of oil and gas from these wells. Non-removal and build up of these liquids will cause oil and gas production to reduce and even shut-off. Wells with this problem exist world wide, with many deeper and more mature wells concentrated in the U.S.

The problem is a convergence of several natural forces that cause severe problems in continuing operation of gas wells, especially deep wells, as they age. These problems are 1) As wells age the pressure out in the reservoir rock decreases (called depletion) reducing the drive and the gas flow rate into the wellbore. 2) Decreased rates of gas flow reduces the velocity that help keep liquids lifted out of the well and prevents them from accumulating and becoming a problem. Lower rates may not be able to lift all the liquids, allowing them to accumulate in the well. 3) Accumulated liquids in the well that are not removed create a backpressure on the gas, which reduces the gas influx from the reservoir into the wellbore, reducing the gas rate even further. 4) Accumulated liquids build pressure on the reservoir pores and allowing water to enter small pores by capillary pressure, thereby reducing the relative permeability of gas through that critical part of the reservoir near the wellbore and fracture faces-reducing gas rate further. Collectively, these factors cause a build up of liquids in gas wells that can decrease the wells' gas production and even kill production from the well.

Methods to pump liquids out of wells are many and maturely developed. Deeper wells (8000+ feet in depth from the surface) still represent a problem in that few options exist and none are perfect. Plunger lift systems are good and cheap, but they lose a fixed percentage of their lifted liquids for every 1000 ft. of lift, consequently the deeper the lift the lower the efficiency. Also, the longer the travel the quicker the sealing rings wear-especially true in older wells with rougher pipe walls, so all the liquid above a plunger can be lost when lifting from 8,000+ feet. Plunger lift methods cannot reduce the reservoir pressure fully, due to the needed energy to lift the fluids and plunger to the surface. This increased pressure means that significant gas reserves are left in the reservoir because they cannot be produced to the surface by this lift method.

Straight gas lift systems are too expensive due to the need to compress gas, use of natural gas or electricity to drive the compressor and inefficiencies of the lifting process. Large volumes of gas are needed to start the unloading process and keep liquids unloaded by this method. Gas lift methods cannot reduce reservoir pressure fully due to the needed energy to lift the liquids at least up to the gas injection point. This increased pressure means that significant gas reserves are left in the reservoir because they cannot be produced to the surface by this lift method.

Very large and costly rod-beam surface pumping units with rod strings extending down to a downhole positive displacement pump can pump below 8,000 feet, but are very inefficient due to rod stretch on every stroke and moving large masses. This method provides a rod string movement at the surface and transmits some of that movement to a piston or plunger (positive displacement type) pump located at the bottom of a tubing string. At some load conditions (i.e. depth, pressure, pump rate and stroke speed) the net stroke length downhole is zero, thus no fluid is pumped although rod movement and wear on the tubing continues. As depth increases this type pump system becomes less efficient, more problematic and expensive to install and operate.

Only positive displacement pumps can perform the high pressure, low rate functions needed by industry in these deep wells. A method to stroke such a pump at the pump's depth is also required to minimize mechanical distance limitations.

Positive displacement pumps are old art. The most common types are piston (traveling/stroking rod with a piston and seal on the forward or tip travelling end), plunger (traveling rod with a seal on the base static end), diaphragm and other types. Only the piston, plunger and combination of the 2 methods are of interest. Their development and technology are well refined for up to 90,000 psi. Pressures up to 60,000 psi are routinely utilized in clean water jetting surface applications (piston and plunger type intensifier and pumps manufactured by KMT, Flow International, Jet Edge). Downhole pumps for oil, water and gas production are modified plunger pumps manufactured by Burleson Pump and Harbison-Fisher Pumps. Material science has improved tremendously over the last two decades to where such pressures and operational life in difficult environments are possible and can be economical.

The limited size or diameter that is available for the pump and power package is the primary constraint. In many cases for these deep well applications pumps with less than 2 inches outer diameter are required to fit within a 2⅜ inch nominal size tubing. Many rod-beam pump units connect to a downhole pump that is often less than 2 inches in diameter, thus that basic pump technology is well known. However such pumps require significant stroke force that is limited by surface rod-beam type and hydraulic drives due to frictional losses. Such diameters also restrict most downhole electric motor applications in this environment. The challenge is to have a drive and pump assembly design that meets the pressure and rate requirements of deep applications and still be within the material strengths and drive abilities. This can be accomplished by proper utilization of downhole electric linear drives indirectly coupled to a well fluids pump (plunger piston, hybrid, or other type positive displacement type pumps)) via a downhole hydraulic pump-drive is an inventive concept of this invention.

Electric drives for pumps (including plunger/piston types and centrifugal) are common for both surface and subsurface applications. The surface applications are seen in a wide variety of industrial and consumer applications. The down hole applications can be seen in the hundreds of thousands of downhole submersible centrifugal pumps (rotary electric motors up to hundreds of horsepower) installed in oil well pumping applications world wide (providers—Schlumberger, Woods, Centrilift, and others). In all cases these are rotary motors turning rotary pumps.

One type of linear actuator is a linear synchronous permanent magnet motor drive that is viewed as highly efficient and provides compact solutions over a wide range of speed. The translational magneto-motive force is created by the virtue of position dependent excitation of the stator electric coils. The electro-mechanical energy conversion is accomplished as a result of interaction between the magnetic fields of the permanent magnets and the traveling magnetic field of the stator. Using adequate control of the stator current waveform high grades of performance can be achieved.

Of newer design are synchronous reluctance machines (SRM's) that do not use permanent magnets that can degrade with time and higher temperatures. Similar sequencing of the coils is required and somewhat lower power output density is obtained.

Despite the wide use of linear electric motors and of positive displacement pumps, it is well recognized in the industry that a combination of both has serious limitations. Addressing those limitations is an aspect of the instant invention. Small available diameter in down hole applications causes low power density which required increased length of the linear electric drive as the depth increases and/or volume rates increase. This it due to the restricted available diameters in many wells, typically 3 inches down to 1.5 inches diameter. This additional length required to provide a set power level directly to the pump causes problems handling such equipment in the field.

Those same length and diameter concerns causes a greatly reduced effective rotor or mover diameter used to transmit that generated power to the pump. Increased stress on such rotor/mover can cause yielding, stretching or buckling of that rod/rotor/mover. Keeping below that stress levels limits available mechanical power that can be transmitted through and out of the electric drive. This further restricts available materials and causes timing issues within the electric drive due to yield and stretch of the rotor materials.

While bi-directional power from the electro-magnetic drive system is available and many types of positive displacement pumps can utilize bi-directional pumping, that power cannot be fully delivered to the mechanical system of the drive. This is because the restricted diameter of the rotor power rod also restricts the power that can be transmitted in a rod/mover in compression mode or direction due to buckling.

Linear drives are optimized at high linear velocities, as measured in feet and hundreds of feet per second. When optimized such drives are more efficient and have lower power demands. As noted previously, linear drives of the type needed have compression limitations of power rod/mover/rotor due to buckling concerns. Thus for the applications considered, they provide power best in the tension direction. This limits drive stroke speed and/or stroke length and is not optimum for the needs of well fluid pumps.

Optimum well fluid pump operation is a slow, as measured in feet per minute, and long, as measured in many feet, and by stroke in a preferred bi-directional or dual pumping action. This allows for longer pump life and capabilities to better handle solids, gases or gasified liquids. Solids are best handled by material changes and by double valving or special valving.

Gases or gaseous well fluids can cause ‘gas lock’—where the change in the pump volume during a stroke cycle cannot discharge accumulated gas against well tubing pressure (at the discharge of the pump). This is a problem with short stroked well fluid pumps that cannot compress the internal gas volume sufficiently above the discharge pressure. It is a result of the natural gas laws. Assuming a constant temperature and the same gas at and through the well fluid pump, the gas law equation is simplified to:

P₁ times V₁ is equal to P₂ times V₂

Where condition 1 is at the end discharge state within the pump and condition 2 is at the end suction state within the pump, P is pressure (any consistent absolute unit) and V is volume (any consistent unit) within the pump. Thus inverse relationship exists between pressure and volume. For a 10,000 foot well that (simplified) has minimal intake or suction pressure of 50 psia and 0.435 psi/foot hydraulic gradient in the earth, this pressure ratio (P₁/P₂) is 87. Thus for a full gas filled pump the change in pump volume must exceed that ratio. For a 2″ pump in this application with 1″ dead space that cannot be displaced, this means that the effective pump stroke must be at least 7.3 feet long.

Fast stroke speeds can also cause gas formation by cavitation or flashing the well fluids by inducing a temporary low pressure at the pump intake or within the pump chamber itself. In many downhole oilfield cases this stroke speed is limited to 15-20 strokes per minute. In surface applications it can be as high as 200 to 500 strokes per minute. Either stroke speed is less than the optimum for most all electric linear drives using electro-magnetic drive means.

Thus a pump for well fluids that has a long stroke (relative to its volume and depth) and is stroked slowly is preferred. Also preferred is a linear electric drive down near the well fluids pump that is stroked at its optimal high speed and at a shorter stroke length.

Many downhole applications force the operator to place a pump above the producing perforations or entry point into the well that allowing a mixture of gas and liquids to be present at the pump inlet. Thus on the well fluid pump's intake stroke both liquids and gases can be taken into the pump chamber and gases interfere with proper pump operation.

Other times the operator must place the pump under a tubing-casing seal or packer that forces all produced well fluids (liquids and gases) into the tubing to get to the surface. This can be due to lift efficiency requirements or damaged casing or perforated casing above the packer that must not be comingled with the desired produced fluids. As the well pressure declines these fluids cannot reach the surface requiring the assistance of a pump. In these cases all well fluids, including gas, must go through the tubing and downhole pump, pressurized and then discharged into the production tubing or flow path to the surface. In the case where a packer already exists or the tubing is already set at a depth above the perforations, running a pump that can handle such gas is preferred so that a rig is not needed to change the downhole configuration, if possible.

It is also desirous to not require an expensive rig or large service unit to pull the tubing or handle rods on a well to run or retrieve the down hole pump. Sometimes this greatly delays pump replacement if a rig is not available or the well site is too small (such as offshore or urban locations). Some patent prior art has shown running electric linear driven pumps in wells on electrified wires and cable or coiled tubing. This is desirable, however as such pump-drive assemblies are placed in deeper applications, the hydrostatic head in the tubing is sufficiently greater than the pressure at the pump suction generating sufficient forces to keep the pump seated and preventing the cable alone from retrieving the drive-pump assembly.

This hold down force follows from the general physical law of F=P×A, where F is the force pushing the pump down onto the seal, P is the pressure differential across the pump and A is the effective area (pump diameter or seat internal diameter) that the pressure is impacting. For a 5000 psi differential and a 1 square inch area this calculates to a 7,850 lb force required to overcome before the pump can be pulled and removed from the well. In addition, friction in the seal and solids build-up over the pump operating life also causes resistance to movement. The cable diameter and material yield strength are limited in many cases. For example, a 0.25-inch diameter solid strand stainless steel cable with a yield strength of 80,000 psi and using a safety factor of 2, can pull a maximum of about 2000 lbs force at the surface. Thicker diameters and multi-strand stainless steel cables can be used. Weight of the electric wires, cable itself and drive-pump must be deducted to get to the effective pulling force that can be generated at the pump seat/seal.

Current methods to remove such pumps at depth require an expensive service rig to run rods to ‘fish’ out the drive-pump assembly, fishing “jars° to help release the pump, a rig to pull tubing up to the pump assembly or to pump liquids down the tubing backside (between the casing and tubing), so that the pressures are equalized or near equalized across the pump seat/seal with the tubing. Pumping liquids or pressuring up can damage the productive formation or damage the casing, even if a packer is not in the way preventing such actions from reaching the pump seal. Methods to unseat the pump without a rig (ie using cable only) are preferred.

Methods to equalize the pressure across the pump seal at the bottom of the tubing or flow path in the instant invention include breaking a seal between the well fluids pump standing valve or suction check valve and the pump-tubing seat/seal by means of an electric actuator striking and breaking a glass plug in a port seal. Also proposed are electric actuated wedges driven into sealing points between the pump-tubing/flow path seal or between well fluids pump valves (e.g. ball and seat type), to open and prevent sealing at these points. Reverse flow from the tubing or well flow path to the surface back into the well casing will eventually equalize the pressures across the pump seal. Alternately, electric actuators can strike or open both standing valve and traveling valve balls or stems to simultaneously or concurrently off seat both them allowing reverse flow and pressure equalization. Other methods that can utilize the downhole electric power and control to off-seat seals and allow reverse flow and equalization are also possible.

Additionally, due to the above mentioned reasons, method to utilize the downhole pumps to strike or ‘jar’ the assembly upward to help unseat or downward to seal the assembly to the downhole tubing or flow path seal. Removing or delaying the limit switches on the pump movement allowing over travel in one direction can accomplish this. This will allow the pump mover to strike the top or bottom of the pump housing or seal member causing a jarring action on the assembly. This can be repeated as needed until the desired assembly movement result is obtained. Over-travel of the well fluid pump piston can also be used to unseat valves on an extended stop.

There is a need then for a new pumping approach for deep well systems that address the aforementioned limitations of existing systems. In particular a method is needed to convert optimum high velocity stroke of electric linear drives to optimum low velocity for pumping well fluids. Also a new pump assembly and method to convert the optimum short stroke of electric linear drives to the long stroke needed for well fluid pumps. In addition there is a need to convert the tension only power stroke of electric linear drives into the dual direction pump action needed in a deep well. In addition there is a need for methods to equalize pressures across pump seals so that the pump assembly can be released and pulled in deep applications without a service rig on location.

Considerable time is expended with a service rig onsite to assemble or make-up the pumps, electric drives and cables for running into or breaking down or disassembling the drive, pump when pulled. A method to make such running and retrieving faster where the assembly and disassembly is performed offsite is preferred and will save time and money.

### SUMMARY

The needs discussed above are address by the instant invention.

The inventive concept is a downhole pump assembly that combines a controllable downhole electric linear drive to actuate a hydraulic pump-drive that then operates a positive displacement pump for pumping well fluids. Thus the electric linear drive's limited stroke and power is converted to a dual direction, slower speed, longer power stroke that is needed to then drive a positive displacement well fluids pump system.

One aspect of the invention is then a downhole pump assembly for removing volumes of liquids, crude oils, gases, and produced waters from oil or gas wells including at least a downhole controllable electric linear drive; a hydraulic pump; a hydraulic drive; and a positive displacement type pump; wherein the controllable electric linear drive drives the hydraulic pump and the hydraulic pump drives the positive displacement pump

Another aspect of the instant invention is the use of an energy storage mechanism, such as a drive spring system or gas chamber, powered by the electric linear drive, to drive the one stroke direction of the positive displacement hydraulic pump.

Another aspect of the instant invention is a drive-pump assembly combination that includes a combination of continuous coil tubing or strength cables and electrical wires (power and bi-directional signals) that enables operation and retrieval of the pump-drive assembly back to the surface. The coiled tubing can provide a flow path down to some point in the well for chemical injection or as a production flow path to the surface and/or as the strength member for the wireline and for pulling or retrieving the pump-drive assembly.

Another aspect of the instant invention is the use of multiple methods of releasing pressures between the production or tubing flow paths and below the pump-drive assembly (in the production casing or liner) to allow easier release of the drive pump assembly from the tubing-pump seal. These methods are applied between the pump-tubing seal (typically in a seating nipple of the tubing) and the top valve seal of the well fluids pump. These methods include the use of an electrically actuated driven wedge into a seal, pump-tubing, ball-seat or valve seat; an electrically actuated pin to keep a valve off of a seat; electronically sensing and controlling the position of the downhole well fluids pump's traveling valve onto an extended pin; and an electrically actuated rod that breaks a glass sealing port

The positive displacement pump may be at least a plunger type pump, a standard sucker rod plunger, a piston type pump, or a diaphragm/bladder.

The wireline/cable may include a narrow diameter stainless steel, or similar, coil tubing to provide chemical treatments into the well from the surface to some depth, including down to the pump or through the pump. The coil tubing may also act as the tension strength cable.

The pump and electro-mechanical actuator may be attached to and run on the bottom of coil tubing. The power and bi-directional signaling wireline of such a method can be strapped to the outside of the coiled tubing or still reside inside the coiled tubing. In this case the coiled tubing may act as the tubing and is the flow path to the surface.

A fishing neck assembly may stick above the pump housing with that will allow the wireline to be pulled off the top of the pump allowing mechanical means, if electricity fails, to retrieve the pump. This can be accomplished by running sucker rods or coil tubing or wireline with a jarring fishing tool, known in the industry, to attach to the top of the pump assembly.

Pressure transducers, piezoelectric gauges, strain gauge or other pressure measurement devices, corrected for temperature, if needed, may control the pump assembly operation by on-off, stroke speed and/or stroke length changes of the electric drives and pumps. Temperature sensors for pump-operating heating may also be monitored for pump operation and control. Of special interest is the measurement of suction or intake pressure to prevent ‘pump off’ conditions that could damage the pump due to changing well conditions.

Another aspect of the instant invention is that the pump assembly can be operated outside of its normal stroke length interval of the rotor such that it will jar the pump in either direction.

Another aspect of the invention is that the entire pump-drive-wireline assembly can be assembled offsite, transported to the well site as a coil spool in about 6-8 ft diameters and can be directly unspooled into the well without a service rig.

Another aspect of the invention is that the pump drive assembly that can be run into a well, by means of a strengthened cable or continuous tube with electrical power and bi-directional signaling wires; electrically operated and controlled from the surface for the duration desired; electronically actuated released from the downhole seal with the tubing; and retrieved to the surface using the strength cable or coiled tubing.

### BRIEF DESCRIPTION OF DRAWINGS

FIG. 1 is a side cross section of a complete proposed downhole pump-drive assembly of the instant invention.

FIG. 2 is a cross section of the electric wire line and the top part of an electric linear drive that is powered and controlled from the surface and/or a downhole controller.

FIG. 3 is a cross section of a drive spring section (at the base of the electric linear drive), and a seal section leading into a high-pressure hydraulic pump.

FIG. 4 is a cross section of a hydraulic pump centered in a fluid reservoir that is powered and controlled by an electric drive and downhole controller.

FIG. 5 is a cross section of a control valve that directs fluids from a hydraulic pump to either side of a hydraulic drive.

FIG. 6 is a cross section of a hydraulic drive operated by a hydraulic pump via a control valve.

FIG. 7 is a cross section of a seal section between a hydraulic drive and a positive displacement pump for pumping well fluids.

FIG. 8 is a cross section of a positive displacement pump for pumping well fluids of the piston type with traveling valve shown.

FIG. 9 is a cross section of a standing valve and equalization section of a downhole pump assembly.

FIG. 10 is a cross section of the displacement pump section of a downhole well fluids pump when the pump is of the plunger type. An equalization section is also shown below the pump section.

### DETAILED DESCRIPTION

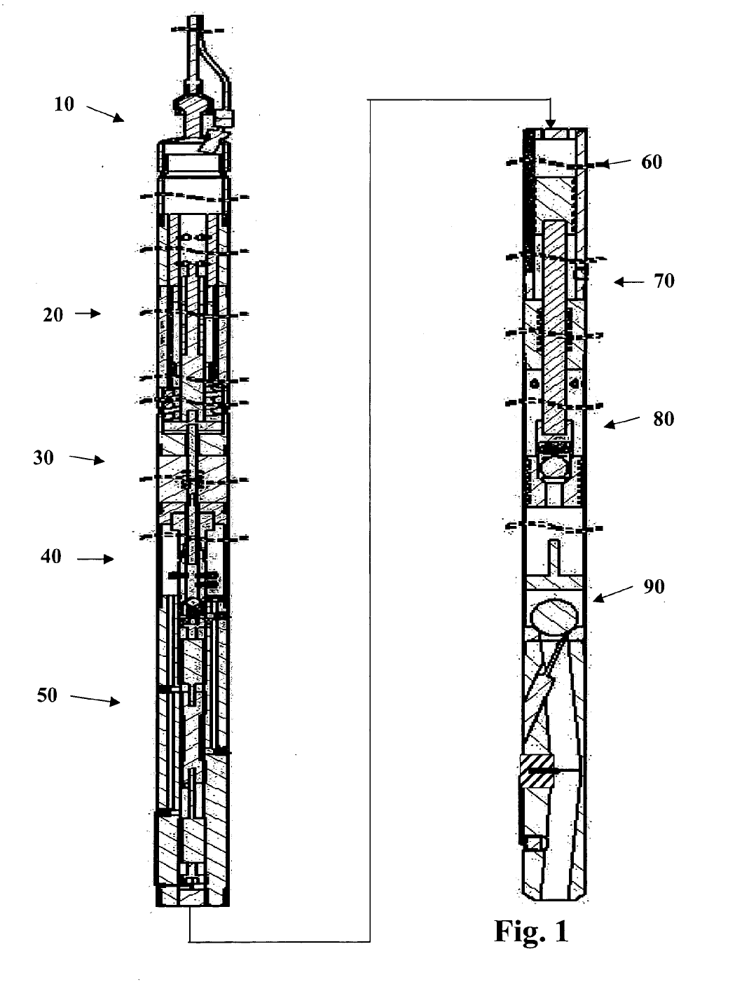

FIG. 1 is a longitude axial cross section of one example of a complete drive-pump assembly of the inventive concept. This complete assembly would be run into and set at the bottom of a tubing string in a down hole application to form a seal. I can be preassembled offsite, coiled for transportation, and uncoiled as it is run into the well. It's basic components include: a top wireline/cable or coil and connection 10; an electric linear drive 20; a drive spring 30 connected to the moving rotor element of the electric drive 20; a seal section on the shaft; a high pressure hydraulic pump 40 (plunger version shown) set inside a reservoir volume of hydraulic fluids (equalization section or expansion bladder not shown); a control valve 50 for directing pumped high pressure fluids from the pump and return fluids to the reservoir to either side of the hydraulic drive 60; a hydraulic piston drive 60; a seal section 70 on the shaft/rod; a well fluid pump 80 (piston version shown); and a valving and equalization section 90.

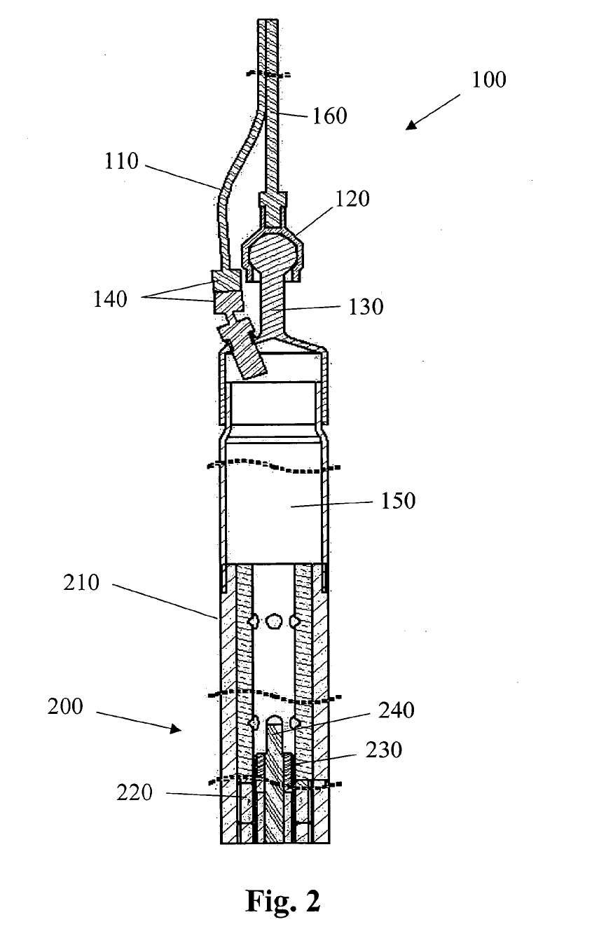

FIG. 2, shown generally by the numeral 100 is a longitude axial cross section of the electric wire/wireline/cable, connector and the top part of the electric-magnetic linear drive. Strength cable 160 with electric wires 110 attached to or integrated into the cable extends from the surface down to the top of the pump-drive assembly. The cable is attached to a ball type fishing neck 130 with a pre-set tension breakaway connection 120 on the ball. The electric wireline 110 has shielded wires that extend from the surface and connect to the top of the pump-drive assembly via connectors 140 that also breakaway at some pre-set tension that is less than the tension settings of 120-130. The wires from the wireline 110 connect into the instrumentation and control center 150 that monitors sensors and surface signals via the wireline 110 for proper operation of the pump-drive assembly. Controller 150 is wired to the surface for electrical power and for bi-directional signals, and is wired to sensors in and below the pump-drive assembly and to the electric linear drive section 20 to control the drive operation. The control functions include monitoring signals from the surface, monitoring pressures (from the tubing or from below the standing valve tubing, annulus pressure and/or pump suction pressure), electric drive control (length of stroke, stroke per minute, start and ending of the drive stroke position), sensing and controlling the hydraulic pump and drive (stroke per minute, stroke length and over-stroking), temperature (sensor not shown) of hydraulic reservoir fluids and other functions.

Breakaway connector 120 allows the cable to free itself, if needed, at some preset tension. Once the cable and wire are free other stronger tools can be run into the well to attach to the fishing neck ball on 130 to mechanically pull the pump-drive assembly out of the well tubing. The electric drive section 200 is as long as needed to provide the power to compress the drive spring 330 on the suction (upstroke) stroke of the hydraulic pump 420. The linear electric drive can be of any electro-magnetic type including induction, permanent magnet synchronous machine (PMSM) or synchronous reluctance machine (SRM) types. The electric drive 200, in it's simplest form, consists of a stator, rotor, wiring harness and controller. The stator consists of the housing 210, wiring and electric coils 220. The rotor or mover consists of the power rod 240 and, if needed, permanent magnet 230. Ports 260 in the housing 210 into the open top area 250 of the mover stroke prevent hydraulic locking. Control board details 150 are not shown. Selected coils 220 are sequentially operated to provide a bidirectional force onto the rotor (power rod 240 and permanent magnets 230). Bearings (not shown) are integrated within the stator or are spaced along the drive as needed.

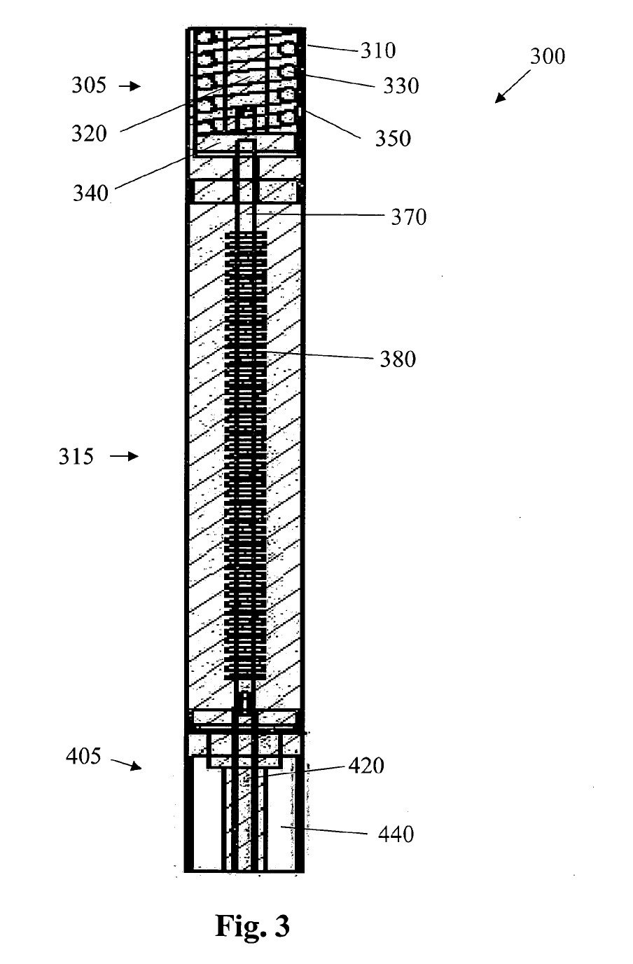

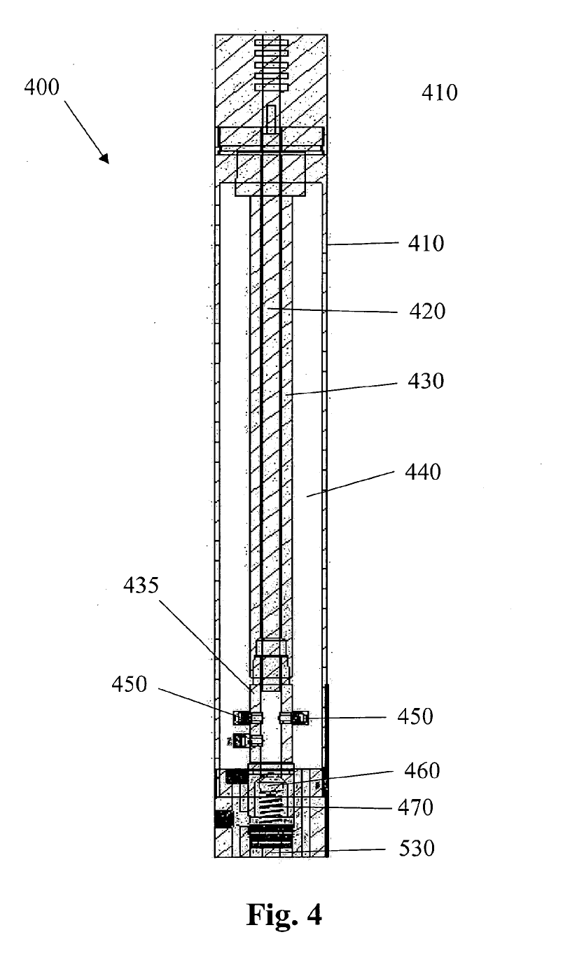

FIG. 3, shown generally by the numeral 300, is a longitude axial cross section of the lower end of a drive spring section 305 and the seal section 315 leading into the high-pressure hydraulic pump, the upper part of which is shown as 405. The electric linear drive provides a forceful movement to the power rod 240 connected to spring shaft 320. As the electric drive is actuated in an upward movement, shaft 320 is moved upwards, moving spring stop 340 and compressing a drive spring 330. At the end of the upward stroke and maximum spring compression, the electric linear drive is switched or turned off and the overall motion is reversed. Ports 350 on the housing 310 allow fluid communication to the tubing of any fluid movement to prevent generating trapped pressure and ‘hydraulic lock’. The spring 330 forces a downward stroke on the shaft 370 through seal section 315 and seals 380. Seals 380 can be of any standard industry type, including viton element and spring loaded elements that can provide a pressure seal against the pressure generated in the high pressure hydraulic pump (shown generally as 400 in FIG. 4). The seal shaft 370 is connected to the plunger 420 of the hydraulic pump 405 and transmits motion from the electric drive rotor and drive spring 330 to hydraulic pump 405. The drive spring acts as an energy storage device. The energy storage device of this invention could also be a gas chamber.

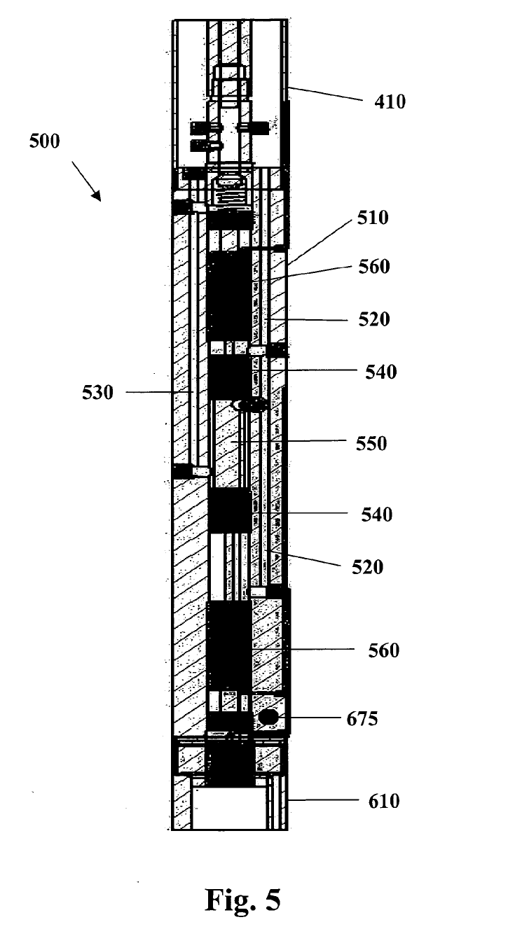

FIG. 4, shown generally by the numeral 400, is a longitude axial cross section of the hydraulic pump. The electric linear motor rotor and drive spring 330 provide force and movement of the plunger 420 within the cylinder 430, 435. Suction check valves 450 open on the upstroke or suction stroke of the plunger 420 allowing fluids in the reservoir 440 to enter the pump cylinder 430, 435) while the discharge pressure check valve 460 is closed by spring 470. At the top of the stroke when the cylinder 430 is filled the plunger is forced down generating pressure and closing suction valves 450 and opening discharge valve 460 against spring 470. Pressurized fluids leave cylinder 430 down flow path 530 to the control valve described in FIG. 5. A pre-pressurized or charged bladder or a piston chamber in or connected to the reservoir 440 is not shown, but is required if a closed system is desired. These equalization methods are long standing and well known in the industry.

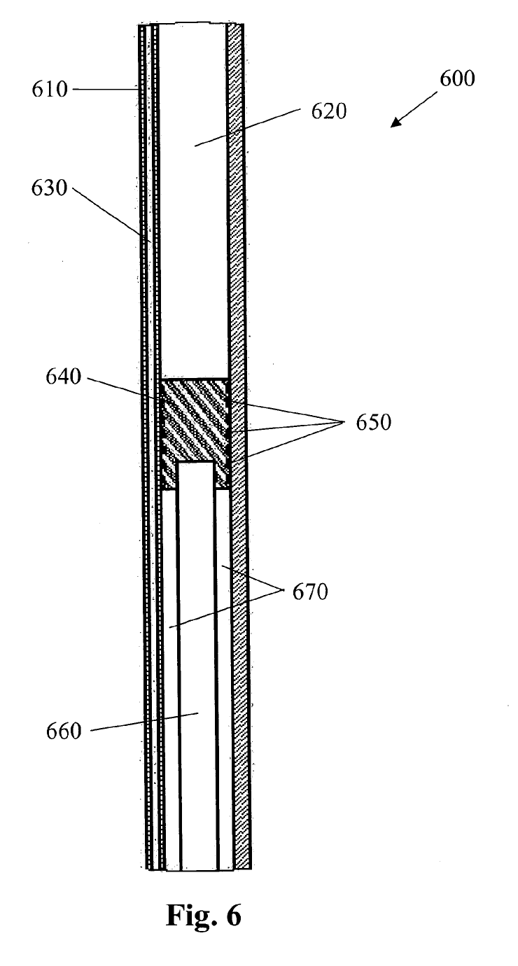

FIG. 5, shown generally by the numeral 500, is a longitude axial cross section of the control valve that directs fluids from the hydraulic pump of FIG. 4 to the hydraulic drive described in FIG. 6 and back to reservoir 440 of FIG. 4. In this version, it is controlled by electric actuators 560 that are actuated by electric sensors at the top and bottom of the hydraulic drive. Other means to sense position and shift the control valve exist in industry, including mechanical linkage to the hydraulic drive piston position.

The control valve of FIG. 5 is of a modified version in that high-pressure ends are in the center and low-pressure ends are on the ends of the valving. Electric actuators 560 are fitted at both ends of a moveable cylinder or spool 550 that has sealing elements 540 on each end on its circumference. Cylinder 550 has a reduced diameter and/or ports drilled in the areas between the sealing elements 540 to allow flow through it from one side of high pressure port 530 to either the upper chamber of the hydraulic drive or the lower chamber of the hydraulic drive as it shifts or slides between ports. When shifted away from a port the return flow from the hydraulic drive bypasses the control valve cylinder 550 and seals 540 and communicates with and flows through paths 520 to the reservoir 440 of FIG. 4. Well fluids flow is upwards on the outside of housings (410, 510 and 610) to provide cooling of the hydraulic fluids in reservoir 440 and high-pressure pump (420 and 430 of FIG. 4).

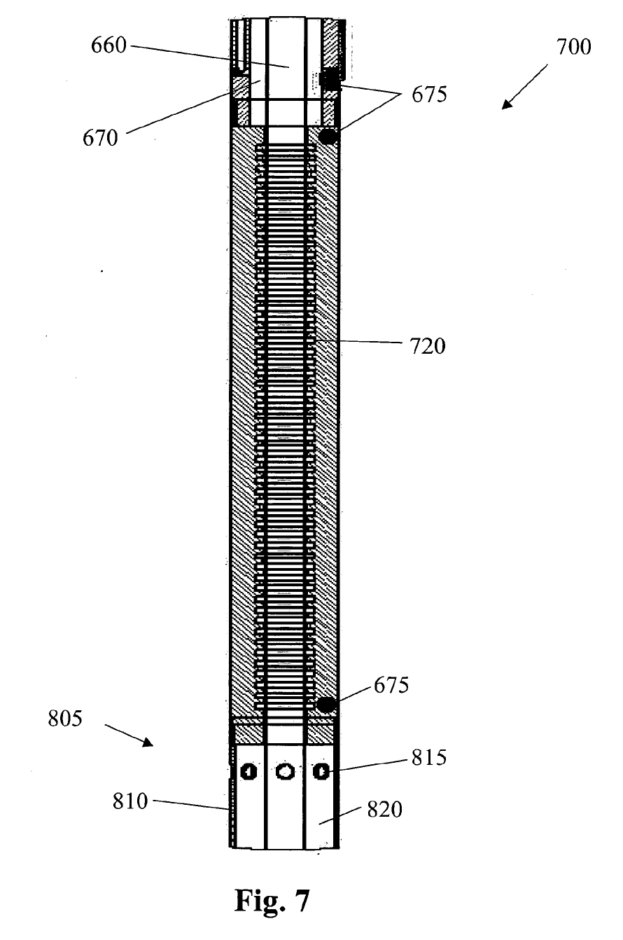

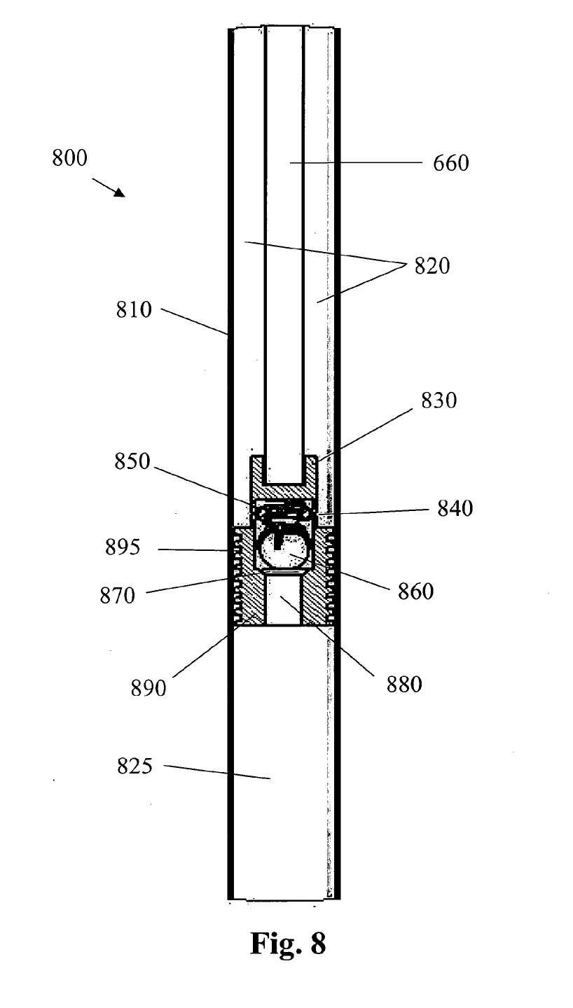

FIG. 6, shown generally by the numeral 600 is a longitude axial cross section of the hydraulic drive. It consists of housing 610, rifle bored path 630 to the lower chamber 670 of the drive, upper chamber 620, piston 640 with seals 650 and shaft 660. Fluid flow and hydraulic pressure from the pump 400 is directed through the control valve 500 into either side of the drive 600 to cause alternating bi-directional vertical movement of piston 640 and shaft 660. Bore 630 allows flow to and from the lower chamber 670 back to the control valve shown in FIG. 5. Shaft 660 connected to the piston 640 continues down through seal system described in FIG. 7, into the well fluids pump shown in FIG. 8 and connects to pump piston 890 of FIG. 8. Relative diameters of piston 640 and shaft 660 determines the movement rate of the piston 640, required pressure from the hydraulic pump of FIG. 4 for movement, and the amount of well fluids pump (of FIG. 8) by that movement. It is not required that the hydraulic system (reservoir, pump, drive) be fully sealed.

FIG. 7, shown generally by the numeral 700, is a longitude axial cross section of the seal section between the hydraulic drive of FIG. 6 and the well fluids pump of FIG. 8. It allows the hydraulic fluid system to be closed and provides a pressure seal to allow movement of drive piston 640 of the hydraulic drive. It can be of standard industry design for sealing linear shaft movements, including spring loaded flexible elements. Electric mass sensors 675 are shown positioned at the top and bottom of the seal assembly 700 and are inserted from the outside and sealed with wires extending out and wired to the control valve. Power is furnished from the top cable/wireline through the control unit 150 for actuating the control valve and sensors of FIG. 5. The well fluids pump of FIG. 8 is threadably connected to the seal section of FIG. 7 with cylinder 810, exhaust ports 815 and variable top chamber 820 shown.

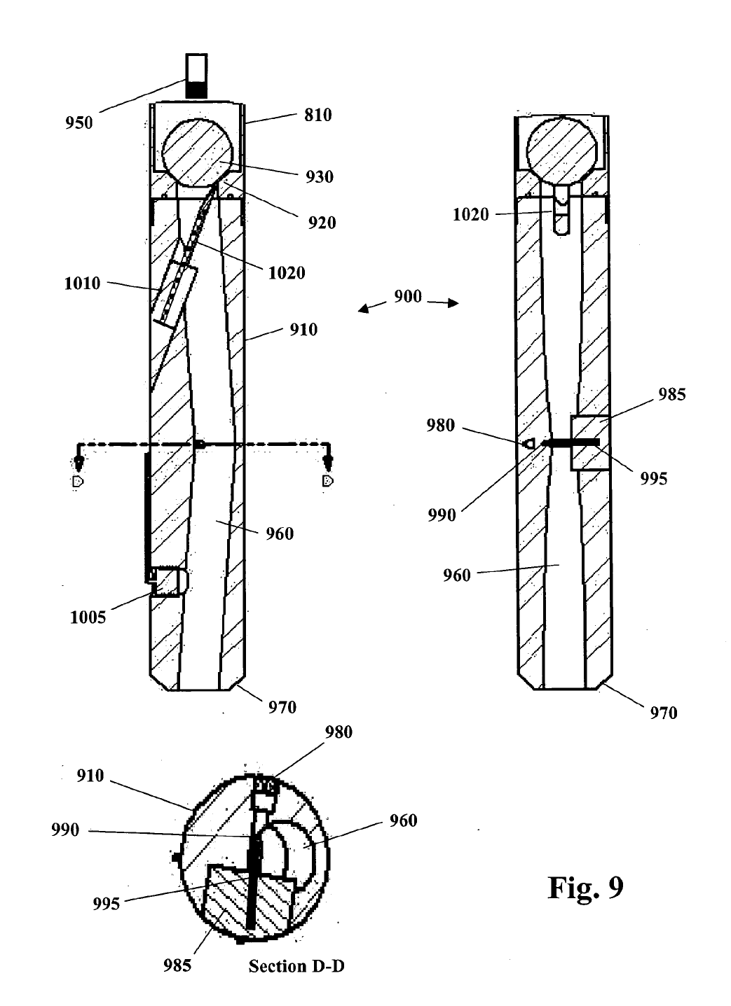

FIG. 8, shown generally by the numeral 800 is a well fluid pump of the piston type. For purposes of the inventive concept, this well fluids pump can be of a plunger type, a piston type, or a diaphragm/bladder type. A housing cylinder 810, shaft/rod 660, upper variable chamber 820, connector 830, ports 840, spring 850, ball 860, seat 870, flow channel 880 in piston 890 with seals 895. Lower variable chamber 825 below the piston is connected to suction or standing valve of FIG. 9.

FIG. 9 shows the standing valve made up of valve ball 930 at the base of the well fluid pump lower chamber 825 closed onto the annular seat 920 and above equalization section 900. The equalization section 900 sits strategically between the suction/standing valve 920/930 of the well fluid pump of FIG. 8 and the tubing-assembly seat/seal 970. The well fluid pump's standing valve ball 930 raises or opens off the seat 920 on the suction, upward or intake stroke of the well fluid pump piston 890 allowing well fluids from the wellbore outside of and below the tubing-drive-pump assembly seal to progress up the equalization section channel 960, through the opened well fluid pump standing valve 920/930 and into the well fluid pump lower chamber 825. At the end or top of the intake stroke of piston 890 standing valve ball 930 closes onto seat 920 and the chamber 825 is sealed. In this regard the standing valve is a one-way valve or a check valve allowing flow only in one direction. On the down stroke of piston 890, traveling valve 860/870 opens while standing valve 920/930 remains closed thus allowing fluids to pass through 880 and 840 into chamber 820. Note that a volume of well fluids will be displaced into the tubing on this down stroke equal to the volume of the piston rod 660 that is extended into the chamber 820. At the bottom of the stroke and upon initiation of the upstroke, the standing valve 920/930 opens, traveling valve 860/870 closes, well fluids are drawn into chamber 825 via path 960 and well fluids in chamber 820 are forced out ports 815 as the piston 890 is pulled up the chamber by rod 660.

The standing valve (seat 920 and ball 930) and the traveling valve (860 ball and 870 seat) of the well fluids pump prevents the tubing and pump volumes from leaking back into the volume outside of or below the tubing-pump assembly seal 970. However, to allow such reverse flow and pressure equalization between the inner and outer volumes of the tubing, i.e. on either side of the tubing-pump assembly seal 970, the equalization section has one or more electrically actuated means to provide a port or opening means to bypass the seal at seat 970. These means include a breakable glass or composite plug 980 in a port that is in fluid contact with both the outer surface of housing 910 and inner flow channel 960. The glass material of the size required must withstand the normal operating differential pressure expected across it, but be brittle enough to shatter when desired. A pointed rod 990 connected to or part of a centralized mover 995 in an electrically activated actuator 985. With a signal from the surface or a predetermined problem downhole, a signal will be given and the actuator 985 will drive point 995 attached to rod 990 into and break glass port 980 allowing flow of fluids from the tubing into the channel 960 and eventually equalizing pressure across the seal 970.

For the piston pump shown herein, electrical means for unseating the traveling valve on the piston (860/870) can be accomplished by use of extended pin 950 fixed in housing 810. A signal from the assembly controller (150 of FIG. 2) or from the surface, causes control valve actuator (560 of FIG. 5) to allow pump piston 890 to over travel a short distance down onto an extended pin 950. Said piston and pumping movement stops and extended pin 950 extends up through the path 880 and pushed valve 860 off seat 870. Simultaneously, a signal is sent from controller 150 to actuator 1010 to drive wedge pin 1020 between the ball 930 and seat 920. Both simultaneous actions will allow reverse fluid flow through the full well fluids pump and pressure equalization across the tubing-assembly seal 970. Alternately an electric actuated pin can be used to off-seat a ball fixed on a (non traveling) valve when not pressurized and keep it open for equalization. Of course, other valve types can be used with the same methods of unseating for pressure equalization.

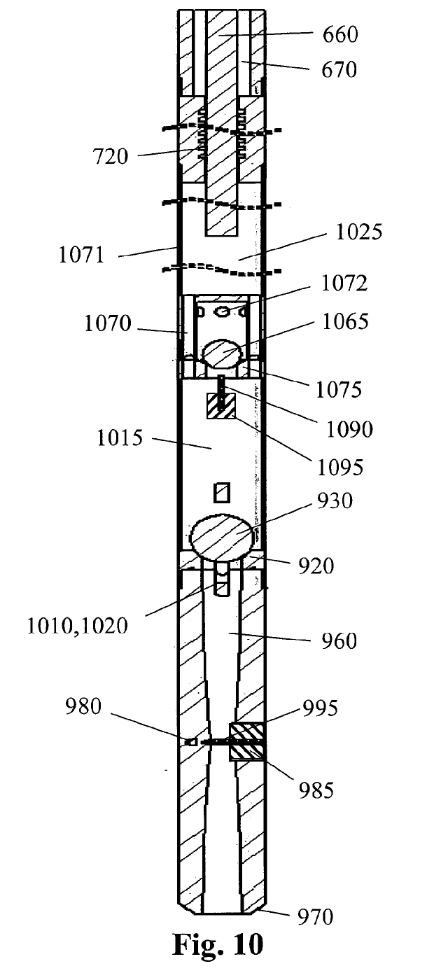

FIG. 10 shows the case of a single acting plunger type pump where both valves (suction and discharge) are stationary and both valves can be forced and kept open by driving a wedge between the ball and seat. This concurrent action also allows reverse flow from the inner to the outer tubing chambers, across the seal 970. This can be seen by actuator 1010 and wedged rod 1020 directed into seal between ball 930 and seat 920. Also use of an electric actuated pin positioned immediately below the valve seat to off seat the balls are possible and contemplated by this invention. Again, other valve types can be used.

The plunger type pump in FIG. 10 operation is a displacement type pump still driven by the hydraulic pump-drive (400-500-600) and seal 700 as described previously. The difference is that housing 1071 internal diameter can be decreased and the shaft/plunger 660 can be increased so that near full bore displacement can be achieved. The standing valve operates as described before. The discharge valve 1065/1075 is now stationary above the standing valve 920/930 and opens when the plunger/shaft 660 extends into pump chamber 1025 and well fluid flow travels through valve 1065/1075 and out ports 1072 into the tubing and to the surface. Well fluids are pulled into chamber 1015 as the plunger/shaft 660 is withdrawn from chamber 1025 to begin a new cycle. Actuated pin 1090/1095 shown positioned below the discharge valve ball 1065 for use in off seating the valve for equalization. Similar staging can be accomplished for the standing valve 930, which shows a wedge type actuated method in FIG. 10. Glass port actuated method 980/985 is also shown positioned below the standing valve and above the tubing-pump seal 970.

A pressure sensor 1005 (of quartz, piezoelectric, strain, or other sensor types), in both FIGS. 9 and 10 is positioned near the base of the equalization section in communication with the channel 960 to measure the well fluids pressure coming into the well fluids pump of FIG. 8. Such a pressure sensor can be installed anywhere on the pump assembly to measure pressure within the tubing and after the pump. Sensor 1005 is powered from and communicates back to controller 150 and the electric linear drive 200 via an insulated wire embedded in grooves on the outside and along the length of the drive-pump assembly to the drive control 150. As intake well fluids pressure declines and to prevent destructive cavitations in the pump and to prevent waste of energy utilized in the pump and to prevent the pump from running ‘dry’ or without liquids of any kind in the well fluids pump, the pressure sensor will indicate that a pre-selected pressure has been reached and the electric drive operation will either be changed for a set period of time, initiate a time delay between strokes, change stroke length, or reduce stoke speed. This will change the well fluids pump via the intermediary hydraulic pump-drive being slowed down. Conversely, if a higher pressure is seen above another pre-selected pressure, the electric drive will be sped up, longer stroked, or decrease any delay between strokes. Temperature sensors (not shown, but similar to the pressure sensors) can be similarly used on and in the assembly.

When it is desired to pull the drive pump assembly out of the well, the equalization actions(s) described above will be initiated to allow pressure to equalize across the seal assembly 970. After some time or when pressure change on sensor 1005 stops, additional signals can be sent to speed up electric drive stroking, causing faster stroking of the overall system as well as a signal to over ride or delay the control valve actuators 560 and allow over travel of the well fluid piston 890 and or hydraulic drive piston 640 to rapidly over travel upward, striking the top of the well fluid pump housing and causing a ‘jarring ’ action of the pump drive assembly. Such ‘jarring’ action often released the seal and accumulated or deposited solids build up on the pump and allows for easier removal of the overall drive-pump assembly from the wellbore.

The actuator 990, and pressure sensor 1005, are wired for power and signals, with the wires positioned to the outside of housing 910 up a groove (not shown) with power from the power supply from surface through controller 150 in FIG. 2. Wired channels inside the assembly body is a possibility, but much more difficult in such small diameters. Grooves can be installed in the assembly after makeup and the wires epoxyed or clamped into the grooves. Wires for these sensors are very small (24 and higher gauge) with the insulator occupying the most volume and require small electrical demand. Actuators and sensors can be threaded into the prepared bore to affect a seal with the wires sticking out the sealed end. Methods to join wires and devices for submerged and pressurized conditions, known as ‘potting’, are well known in the downhole tool and instrument segment of the oil and gas industry.

While one (or more) embodiment(s) of this invention has (have) been illustrated in the accompanying drawings and described above, it will be evident to those skilled in the art that changes and modifications may be made therein without departing from the essence of this invention. All such modifications or variations are believed to be within the sphere and scope of the invention as defined by the claims appended hereto.

1. A downhole pump assembly for removing volumes of liquids, crude oils, gases and produced waters from oil or gas wells to earth surface comprising:
a. a downhole controllable electric linear drive;
b. a hydraulic pump; and
c. a positive displacement type pump;
d. wherein said controllable electric linear drive drives said hydraulic pump and wherein said hydraulic pump drives said positive displacement pump.

2. The downhole pump assembly of claim 1 further comprising an energy storage device, said energy storage device being compressed by an upward movement of said controllable electric linear drive; and said energy storage device being in mechanical communication with said hydraulic pump to then transmit downward motion to said hydraulic pump.

3. The downhole pump assembly of claim 2 wherein said energy storage device is selected from the group consisting of a drive spring, and a gas chamber.

4. The downhole pump assembly of claim 1 wherein said positive displacement pump is selected from the group consisting of a piston type, a plunger type, and a diaphragm/bladder type.

5. The downhole pump assembly of claim 1 wherein said controllable electric linear drive is selected from the group consisting of a permanent magnet synchronous machine (PMSM) type, and a synchronous reluctance machine (SRM) type.

6. The downhole pump assembly of claim 1 further comprising a combination of continuous coil tubing or strength cable and electric wiring connected to a top section of said downhole pump assembly; said combination providing electronic communication for operation and capability for retrieval of pump assembly back to earth surface.

7. The downhole pump assembly of claim 1 further comprising electrically actuated techniques for equalizing pressures across seals and valves to enable retrieval of said downhole pump assembly.

8. A method of removing volumes of liquids, crude oils, gases and produced waters from oil or gas wells to earth's surface comprising the steps of:
a. driving a downhole hydraulic pump by a controllable electric linear drive;
b. using said downhole hydraulic pump to drive a positive displacement pump to remove said volumes of liquids, crude oils, gases and produced waters from oil or gas wells to earth's surface.

9. The method of removing volumes of liquids, crude oils, gases and produced waters from oil or gas wells to earth's surface of claim 8 further comprising the steps of:
a. compressing an energy storage device with said controllable electric linear drive; and
b. transmitting motion to said downhole hydraulic pump with said energy storage device.
wherein said energy storage device can be a drive spring or a gas chamber.

10. The method of removing volumes of liquids, crude oils, gases and produced waters from oil or gas wells to earth's surface of claim 8 further comprising the steps of equalizing pressures across seals and valves to enable retrieval of said downhole pump assembly.
